(19) United States
(12) Patent Application Publication
(10) Pub. No.: US 2025/0005527 A1
(43) Pub. Date: Jan. 2, 2025

(54) PROJECT PLANNING WITH MULTI-DIMENSIONAL VISUALIZATION

(71) Applicant: INTERNATIONAL BUSINESS MACHINES CORPORATION, Armonk, NY (US)

(72) Inventors: Jeremy R. Fox, Georgetown, TX (US); Jana H. Jenkins, Raleigh, NC (US); Melanie Dauber, Oceanside, NY (US); Fang Lu, Billerica, MA (US)

(21) Appl. No.: 18/216,678

(22) Filed: Jun. 30, 2023

(51) Int. Cl. G06Q 10/10; G06Q 10/0631

(52) U.S. Cl. CPC G06Q 10/103; G06Q 10/063118; G06Q 10/06313

(57) ABSTRACT

Aspects of the present invention include setting task management and project management parameters; utilizing a queuing theory calculator for a task and a project management based on various types of multi-dimensional visualization; generating a plurality of results of the task management and the project management based on utilizing the queueing theory calculator; analyzing the results with at least one machine learning algorithm; outputting a multi-dimensional analysis of the results based on the analysis of the results with the at least one machine learning algorithm; analyzing the results using a magic square analysis; comparing the results with a plurality of requirements based on the analysis of the results with the at least one machine learning algorithm and the analysis of the results using the magic square analysis; and determining a subset of the plurality of results that meet a threshold of a comparison of the requirements.

### BACKGROUND

Aspects of the present invention relate generally to project planning with multi-dimensional visualization and, more particularly, to project planning with multi-dimensional visualization for providing intelligent workflow ameliorations.

Computer-based project management must manage project stakeholders and a budget, provide consistent processes and methodologies, and provide detailed planning schedules. Further, computer-based project management involves planning and organization of resources within a computing environment to move a specific task towards completion.

### SUMMARY

In a first aspect of the invention, there is a computer-implemented method including: setting, by a processor set, task management parameters and project management parameters; utilizing, by the processor set, a queuing theory calculator for a task management and a project management based on various types of multi-dimensional visualization; generating a plurality of results of the task management and the project management based on utilizing the queuing theory calculator; analyzing, by the processor set, the plurality of results with at least one machine learning algorithm; outputting, by the processor set, a multi-dimensional analysis of the plurality of results based on the analysis of the plurality of results with the at least one machine learning algorithm; analyzing, by the processor set, the plurality of results using a magic square analysis; comparing, by the processor set, the plurality of results with a plurality of requirements based on the analysis of the plurality of results with the at least one machine learning algorithm and the analysis of the plurality of results using the magic square analysis; and determining, by the processor set, a subset of the plurality of results that meet a threshold of a comparison of the requirements based on the comparing of the plurality of results with the requirements.

In another aspect of the invention, there is a computer program product including one or more computer readable storage media having program instructions collectively stored on the one or more computer readable storage media. The program instructions are executable to: set task management parameters and project management parameters; utilize a queuing theory calculator for a task management and a project management based on various types of multi-dimensional visualization; generate a plurality of results of the task management and the project management based on utilizing the queuing theory calculator; analyze the plurality of results with at least one machine learning algorithm; output a multi-dimensional analysis of the plurality of results based on the analysis of the results with the at least one machine learning algorithm; analyze the plurality of results using a magic square analysis; compare the results with a plurality of requirements based on the analysis of the plurality of results with the at least one machine learning algorithm and the analysis of the plurality of results using the magic square analysis; and determine a subset of the plurality of results that meet a threshold of a comparison of the requirements based on the comparing of the plurality of results with the requirements.

In another aspect of the invention, there is a system including a processor set, one or more computer readable storage media, and program instructions collectively stored on the one or more computer readable storage media. The program instructions are executable to: set task management parameters and project management parameters; utilize a queuing theory calculator for a task management and a project management based on various types of multi-dimensional visualization; generate a plurality of results of the task management and the project management based on utilizing the queuing theory calculator; analyze the plurality of results with at least one machine learning algorithm; output a multi-dimensional analysis of the results based on the analysis of the plurality of results with the at least one machine learning algorithm; analyze the plurality of results using a magic square analysis; compare the plurality of results with a plurality of requirements based on the analysis of the plurality of results with the at least one machine learning algorithm and the analysis of the plurality of results using the magic square analysis; and determine a subset of the plurality of results that meet a threshold of a comparison of the requirements based on the comparing of the plurality of results with the requirements. In particular, the task management parameters and the project management parameters include a complexity of project requirements, a plurality of skill sets of people, availability of the people, a plurality of business processes, and availability of tools.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of a project planning server in accordance with aspects of the present invention.

FIG. 3 shows a flowchart of an exemplary method of the project planning server in accordance with aspects of the present invention.

FIG. 4 shows a data entity contextual diagram of the project planning server in accordance with aspects of the present invention.

### DETAILED DESCRIPTION

Aspects of the present invention relate generally to project planning with multi-dimensional visualization and, more particularly, to project planning with multi-dimensional visualization for providing intelligent workflow ameliorations. Computer-based project management is a complex and challenging process, with many moving parts and stakeholders. Embodiments of the present invention provide effective and efficient project planning. Embodiments of the present invention visualize a project planning process by accounting for a weight of required and optional factors. Embodiments of the present invention reduce budget losses due to poor project performance and increase the likelihood of success of the project.

Embodiments of the present invention improve performance of projects by ensuring that all factors are taken into account during a project planning process. Embodiments of the present invention optimize a project planning process and maximize efficiency. Embodiments of the present invention increase productivity of projects through a processing workflow. Embodiments of the present invention provide a detailed and comprehensive view of a project plan to enhance management of the project stakeholders, budget, and resources. Embodiments of the present invention estimate the time of a team member, an asset utilization, and other factors from a multi-dimension view. In particular, embodiments of the present invention consider factors such as a complexity of a project requirement, a skill set of a person, an availability of a person, business processes, and available tools.

Embodiments of the present invention provide a queuing theory calculator for task management and project management based on a multi-dimensional visualization. Embodiments of the present invention also utilize machine learning (ML) algorithms to build an intelligent workflow that is used to analyze results of calculations and determine the best results for a user. In embodiments of the present invention, the ML algorithms may include linear regression, decision tree learning, support vector machine (SVM), and neural networks. However, embodiments are not limited to these ML algorithms. In embodiments, the ML algorithms build an intelligent workflow that analyzes the result of the calculations and determines the best results for the user. Embodiments of the present invention also utilize a magic square to analyze the results of the calculations and determine the best results for the user for any required factor variable. Embodiments of the present invention enable four-dimensional (4D) analysis using 4D visualization tools such as 4D graphs and 4D charts to visualize the results of the calculations over time iteratively with a delta comparison. Embodiments of the present invention enable three-dimensional (3D) analysis using 3D visualization tools such as 3D graphs and 3D charts to visualize the results of the calculations and compare the calculations to determine the best results for what the user is seeking. Embodiments of the present invention are integrated with various types of project management software and databases.

Embodiments of the present invention improve project performance by providing detailed planning, providing consistent processes and methodologies, and properly managing the project stakeholders and the budget. Conventional systems provide insufficient detail and do not account for all of the factors for successful project management. In particular, conventional systems do not adequately account for complexity of project requirements, skill sets of personnel, availability of personnel and tools, and business processes. Accordingly, conventional systems waste business investments due to poor project performance.

Embodiments of the present invention improve project performance by accounting for all of the factors, during a project planning process, optimizing the project planning process, maximizing efficiency, and increasing project productivity through a processing workflow. Accordingly, implementations of aspects of the present invention provide an improvement (i.e., technical solution) to a problem arising in the technical field of project planning. In particular, embodiments of the present invention help users visualize the project planning process by taking into account a weight of required factors and optional factors. Embodiments of the present invention also estimate the time of the team members, an asset utilization, and other factors in a multi-dimensional view. Also, embodiments of the present invention may not be performed mentally or may not be performed in a human mind because aspects of the present invention leverage ML algorithms, such as linear regression, decision tree learning, support vector machine (SVM), and neural networks to improve project planning.

Implementations of the invention are necessarily rooted in computer technology. For example, the step of analyzing the results of the task management and the project management with at least one machine learning algorithm is computer-based and cannot be performed in the human mind. Training and using a machine learning model and a neural network are, by definition, performed by a computer and cannot practically be performed in the human mind (or with pen and paper) due to the complexity and massive amounts of calculations involved. For example, the support vector machine (SVM) algorithm may perform classification and regression on linear and non-linear data by finding complex relationships between input data. In particular, an SVM algorithm may perform classification and regression on a large amount of data with thousands of features to train the model such that the model generates an output in real time (or near real time). Given the scale and complexity of performing classification and regression on the large amount of data, it is simply not possible for the human mind, or for a person using pen and paper, to perform the number of calculations involved in training and/or using a machine learning model and the neural network.

Aspects of the present invention include a method, system, and computer program product for providing an effective project planning with multi-dimensional visualization which yields intelligent workflow ameliorations. For example, a computer-implemented method includes: establishing the project goals and objectives; defining the project scope by understanding the deliverables, timeline, budget, and other components for successful project completion; analyzing the project requirements and determining the complexity of the project as well as the factors to consider including understanding the scope of the project, the tasks that need to be completed, the resources required, and the timeline for completion; evaluating the team's current skillset and availability and the resources that for the project and availability; inputting the data and parameters into the system such as complexity of the project requirements, people's skills set, people's availability, business processes, and availability of tools; rendering the complexity of the project requirements, people's skills set, people's availability, business processes, and availability of tools into blocks which is a visual representation of the project planning process that takes the weight of required factors and optional factors into account; determining which blocks are required and which blocks are optional; fitting the blocks into a fixed-size container and calculating the amount of effort needed from the required factors and optional factors based on the blocks that fit into the container, which enables estimating the team member's time, asset utilization, and other factors most efficiently from a multi-dimensional view, using a mathematical concept known as a magic square to analyze the results of the calculations and determine the best results for the user's specific requirements for the project; and enabling 4D visualization tools to visualize the results of the calculations over time, yielding a time based variable that enables a data rich and data poor modeling factoring approach. The computer-implemented method further includes which factors are absolutely essential for the project and which can be adjusted or changed if needed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as project planning code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

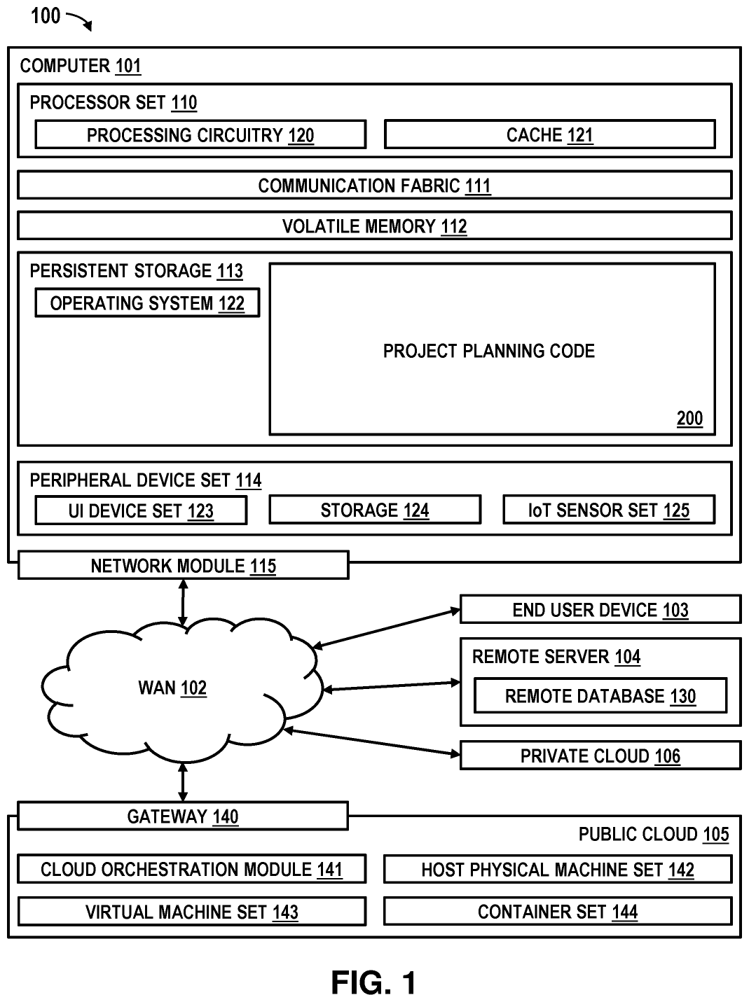

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101.

Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

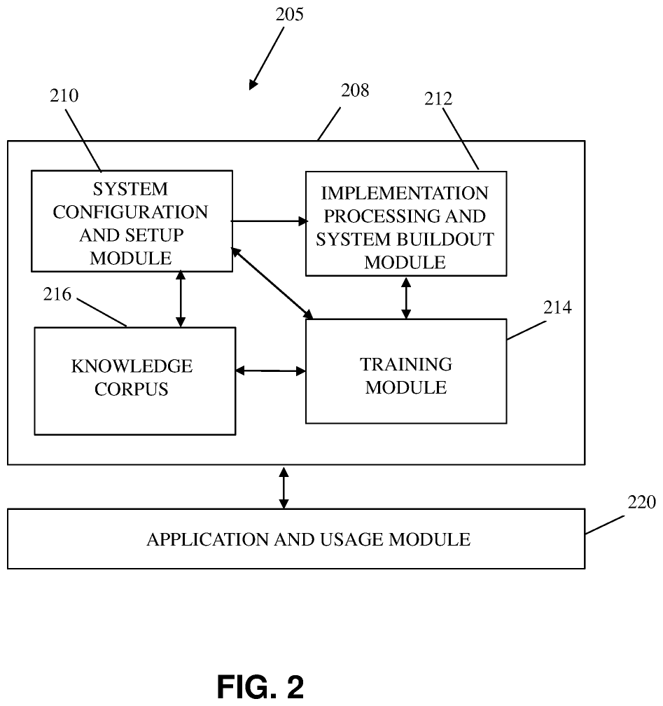

FIG. 2 shows a block diagram of an exemplary environment 205 in accordance with aspects of the invention. In embodiments, the environment 205 includes a project planning server 208, which may comprise one or more instances of the computer 101 of FIG. 1. In other examples, the project planning server 208 comprises one or more virtual machines or one or more containers running on one or more instances of the computer 101 of FIG. 1. The environment 205 also includes an application and usage module 220, which is external to the project planning server 208. Further, the application and usage module 220 communicates with the project planning server 208. In other embodiments, the application and usage module 220 is included in the project planning server 208.

In embodiments, the project planning server 208 of FIG. 2 comprises a system configuration and setup module 210, an implementation processing and system buildout module 212, and a training module 214, each of which may comprise modules of the code of block 200 of FIG. 1. In embodiments, the project planning server 208 further comprises a knowledge corpus 216. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The project planning server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the present invention, the system configuration and setup module 210 configures the project planning server 208 and sets up parameters for a planned project. In particular, the system configuration and setup module 210 sets up a complexity of project requirements, skill sets of people, availability of people, business processes, availability of tools, and other factors for successful project management. The system configuration and setup module 210 defines a size of a box that contains blocks for rendering the blocks in the box. In embodiments, blocks are a visual representation of the project planning process that takes a weight of required factors and optional factors into account. In further embodiments, a box is a visual representation of a fixed-sized container which contains the blocks that take the weight of required factors and optional factors into account. The system configuration and setup module 210 also sets up and manages the knowledge corpus 216 to manage all data, metadata, and variables The system configuration and setup module 210 also configures the training module 214 to communicate and interface with the knowledge corpus 216.

In embodiments, the system configuration and setup module 210 analyzes the complexity of the project requirements, the skill sets of people, the availability of people, the business processes, and the availability of tools to determine an amount of detail needed in the planned project. Further, the system configuration and setup module 210 determines the size of the box that contains the blocks to help optimize the planned project. The system configuration and setup module 210 renders the blocks in the box using the parameters specified in the configuration process to create a visual representation of the planned project by taking into account the complexity of the project requirements, the skill sets of people, the availability of people, the business processes, and the availability of tools. The system configuration and setup module 210 verifies that the blocks are rendered properly into the box and that the appropriate size of the box is being used. The system configuration and setup module 210 visualizes the project planning by taking into consideration the required factors and optional factors and calculates an amount of effort needed from the required factors and the optional factors based on the blocks that fit into the box.

In FIG. 2, and in accordance with aspects of the present invention, the implementation processing and system buildout module 212 ensures that the project planning server 208 is functioning properly by taking into account the complexity of the project requirements, the skill sets of people, the availability of people, the business processes, and the availability of tools. The implementation processing and system buildout module 212 also verifies that the blocks are rendered properly into the box and that the appropriate size of the box is being used.

In embodiments, the implementation processing and system buildout module 212 implements the infrastructure to support the planned project, such as servers and databases for storing and processing data and other applicable hardware and software components. The implementation processing and system buildout module 212 installs and configures the project planning server 208 to verify proper functionality. In particular, the implementation processing and system buildout module 212 verifies that all components are installed correctly and that communication of the project planning server 208 with other components is working. The implementation processing and system buildout module 212 tests the project planning server 208 to verify that everything is working as intended, including running tests to verify an effectiveness of the project planning server 208 and an accuracy of data being stored and processed within the project planning server 208.

In embodiments, the implementation processing and system buildout module 212 utilizes the project planning server 208 to estimate the time of team members, asset utilization, and other factors from a multi-dimensional view. In particular, the implementation processing and system buildout module 212 utilizes the project planning server 208 to visualize the planned project by considering weights of required and optional factors and calculate an effort needed from the required and optional factors based on the blocks that fit in the box. The implementation processing and system buildout module 212 optimizes the project planning by visualizing a process and factor in a weight of required and optional elements and identifying areas where improvements can be made and efficiency can be maximized.

In embodiments, the implementation processing and system buildout module 212 trains at least one user how to use the project planning server 208, including providing guidance and instructions on how to configure the project planning server 208, implement the project planning server 208, and use the project planning server 208 to visualize the planned project as well as how to create and manage projects and monitor progress. The implementation processing and system buildout module 212 monitors the project planning server 208 to verify that the project planning server 208 is functioning properly. In particular, the implementation processing and system buildout module 212 regularly checks the project planning server 208 for any errors or issues and adjusts or updates to ensure optimal system performance.

In embodiments, the implementation processing and system buildout module 212 implements any updates or adjustments to the project planning server 208 to ensure that the project planning server 208 is optimized. In particular, the implementation processing and system buildout module 212 implements any changes or updates that are needed to ensure that the project planning server 208 is working properly and that the project planning is optimized for efficiency.

In embodiments, the implementation processing and system buildout module 212 comprises a queuing theory calculator for task and project management based on the various types of multi-dimensional visualization. In embodiments, the queuing theory calculator comprises a software application for the task and project management. In further embodiments, the queueing theory calculator is used to integrate all the data and parameters to analyze the queues of the tasks and project management to provide various results. Further, the implementation processing and system buildout module 212 infuses the queuing theory calculator into an intelligent workflow at various points of times to yield various results. The implementation processing and system buildout module 212 then compares the various results to provide the best results to the user based on a 4D perspective, which includes a time-based variable with delta-based comparisons iteratively generated. In particular, the implementation processing and system buildout module 212 generates a dynamic multi-dimension project planning, which can be generated hourly, daily, weekly, etc. Additionally, the implementation processing and system buildout module 212 utilizes multi-dimensional visualization tools to visualize the various results of the calculations and compares the various results to determine and provide the best results to the user. In embodiments, the implementation processing and system buildout module 212 implements various coding algorithms that would vary based on the specific requirements of the task management and project management software. In particular, the implementation processing and system buildout module 212 implements at least one ML algorithm, such as linear regression, decision tree learning, support vector machine (SVM), and neural networks to analyze the various results and build an intelligent workflow. In an example, the at least one ML algorithm analyzes the various results using trained models and historical data to build intelligent workflows that show the resource utilization of required factors and optional factors. The intelligent workflows that show the resource utilization of required factors and optional factors are compared with the requirements of the user to provide the best results to the user based on the comparison.

In embodiments, the implementation processing and system buildout module 212 implements a magic square to analyze the various results of the calculations in the task and project management software as well as to determine and provide the best results for the user. In an example, the magic square analyzes the various results by providing a multi-dimensional visualization of the various results to visualize each of the required factors and the optional factors such that it is easy to compare the multi-dimensional visualization of the resource utilization of the required factors and optional factors to the requirements of the user. In other words, the magic square provides the multi-dimensional visualization of the various results to compare the required factors to the requirements of the user to provide the best results to the user based on the comparison. A magic square comprises a square grid of distinct numbers where all rows, columns, and diagonals sum to a same total. In embodiments, the implementation processing and system buildout module 212 implements the magic square in a 3D analysis using multi-dimensional visualization tools such as 3D charts, graphs, grids, and maps. In embodiments, the implementation processing and system buildout module 212 implements the magic square in a 4D analysis using multi-dimensional visualization tools such as 4D charts, graphs, grids, and maps. In other embodiments, the implementation processing and system buildout module 212 implements the magic square in a multiple-dimensional grid using multi-dimensional visualization tools such as multi-dimensional charts, graphs, and maps. Further, the implementation processing and system buildout module 212 uses the multi-dimensional visualization tools to help visualize the various results of the calculations and compare the various results to requirements of the user to determine and provide the bests results for the user. In particular, the implementation processing and system buildout module 212 compares the various results to requirements of the user based on the analysis of the result with the at least one machine learning algorithm and the analysis of the magic square to determine the best results.

In embodiments, the implementation processing and system buildout module 212 analyzes in 4D by adding a time-based iterative delta variable. In particular, the implementation processing and system buildout module 212 analyzes in 4D by incorporating the iterative intelligent workflow into the equation so that the various results of the calculations are tracked over time to see the changes and determine and provide the best results to the user by utilizing the delta of time variables over a larger sample set. The implementation processing and system buildout module 212 analyzes in 4D by constructing the results of the calculations iteratively based on any user provided time variable. The implementation processing and system buildout module 212 visualizes in 4D by using 4D visualization tools, such as 4D graphs, charts, and multi-dimensional modifications.

In embodiments, the implementation processing and system buildout module 212 provides the intelligent workflow to allow a project manager to maintain or discover a plan that is slanted towards various factors. In particular, the various factors may include resource rich planning, funding rich planning, scope rich planning, time rich planning, resource poor planning, funding poor planning, scope poor planning, and time poor planning. However, embodiments are not limited to the above examples and may include other various factors. In embodiments, a triple constraint for 3D visualization includes a resource planning, a funding planning, and a scope planning. In further embodiments, the implementation processing and system buildout module 212 uses the triple constraint with the time planning for 4D visualization. In embodiments, the time planning comprises a predetermined time range for the results. However, embodiments are not limited to the above example of the triple constraint. In other embodiments, the triple constraint may be a user defined pre-set combination of three factors for 3D visualization. In embodiments, the term “rich” corresponds with a large amount and the term “poor” corresponds with a small amount. Therefore, in exemplary embodiments, the funding rich planning refers to a large amount of budget available and the funding poor planning refers to a small amount of budget available.

In FIG. 2, and in accordance with aspects of the present invention, the training module 214 trains a model of the project planning server 208 and populates the knowledge corpus 216 and the usage of the knowledge corpus 216. The training module 214 trains a model within the project planning server 208 with data and expands the knowledge corpus 216 with the data. In particular, the training module 214 trains the model within the project planning server 208 and populates the knowledge corpus 216 with live data. The training module 214 uses complexity dates corresponding to the project requirements, skill sets of people, availability of people, business processes, and availability of tools in blocks. Further, the training module 214 refines the data and metadata to train the project planning server 208 and build out the knowledge corpus 216.

In embodiments, the training module 214 identifies data sources that correspond to the project planning, such as the complexity of the project requirements, skill sets of people, availability of people, business processes, and availability of tools. In particular, the training module 214 searches for publicly available datasets, such as those published by the Project Management Institute (PMI), data that would be specific to a company, and data from internal sources, such as surveys and report. The training module 214 selects and extracts the data that corresponds with the project planning, which includes the most pertinent data points and features for training the project planning server 208. For example, the features that are for training include the complexity of the project requirements, skill sets of people, availability of people, business processes, and availability of tools. The training module 214 pre-processes the data to verify that the data is clean and ready to use. In particular, the training module 214 removes any data or noise and converts the data into a correct format. For example, the training module 214 cleans up the data, handles missing values, normalizes the data, and transforms the data into a format that is used for training the project planning server 208.

In embodiments, the training module 214 loads the data into the project planning server 208 for training. In particular, the training module 214 loads the pre-processed data into the project planning server 208 and prepares the pre-processed data for training. The training module 214 trains the model of the project planning server 208 with data using supervised and unsupervised learning techniques of machine learning and artificial intelligence. In particular, the training module 214 trains the model of the project planning server 208 with data using at least one of regression, neural networks, support vector machine (SVM), and decision trees. The training module 214 evaluates a performance of the project planning server 208 to verify that the project planning server 208 is learning and making accurate predictions. In particular, the training module 214 includes using metrics such as accuracy, precision, recall, and aggregate multi-dimensional scores to assess the performance of the project planning server 208.

In embodiments, the training module 214 adjusts the data and metadata to focus on training the project planning server 208 and improves the accuracy of the predictions. The training module 214 monitors the project planning server 208 to verify that the project planning server 208 is performing as expected. In particular, the training module 214 checks the project planning server 208 for any errors or issues, and adjusts or updates to ensure optimal performance of the project planning server 208. The training module 214 updates or adjusts the project planning server 208 to ensure that the project planning server 208 is optimally functioning. In particular, the training module 214 makes needed changes or updates to ensure that the project planning server 208 is working properly and that the project planning is optimized for efficiency.

In embodiments, the training module 214 utilizes the knowledge corpus 216 to make informed decisions about the project planning. The training module 214 manages multiple factors through successive multiple iterations for a multi-dimensional visualization adding a new variable to each successive iteration. In embodiments, the training module 214 trains a model by receiving a plurality of inputs that may include a user input for project planning, complexity of project requirements, skills set of people, availability of people, business processes, and availability of tools and outputs a weight of required factors, a weight of optional factors, an amount of effort needed from required factors, an amount of effort needed from optional factors, and fixed and variable quantification of data.

In FIG. 2, and in accordance with aspects of the present invention, the application and usage module 220 communicates with the project planning server 208 to assist with the project planning. In particular, the application and usage module 220 uses the project planning server 208 to visualize the project planning by taking into account the required and optional factors and calculates the amount of effort required from the required factors and optional factors based on the blocks that fit into the box. The application and usage module 220 builds out the knowledge corpus 216 over time with successive iterations by communicating with the project planning server 208.

In embodiments, the application and usage module 220 establishes the project goals and objectives and defines a project scope. In particular, the application and usage module 220 defines the project scope by looking at deliverables, timeline, budget, and other components for a successful project completion. The application and usage module 220 identifies project stakeholders and develops a clear plan on how and when to communicate with the project stakeholders throughout a project. In particular, the application and usage module 220 identifies which individuals and organizations are affected by the project and how these stakeholders should be kept up to date on a progress of the project.

In embodiments, the application and usage module 220 analyzes the project requirements and determines the complexity of the project as well as the factors to consider. In particular, the application and usage module 220 determines a scope of the project, tasks that need to be completed, resources required, and the timeline for completion. The application and usage module 220 assesses skills set for a team and availability and resource utilization by evaluating a skill set of the team and assessing resources that are for the project and availability. The application and usage module 220 inputs data and parameters, which includes complexity of the project requirements, skill sets of a people, availability of the people, business processes, and availability of tools into the project planning server 208. Accordingly, in embodiments, the application and usage module 220 runs on a client device and communicates with the project planning server 208 to visualize the project planning.

In embodiments, the application and usage module 220 renders the complexity of the project requirements, the skill sets of the people, the availability of the people, the business processes, and availability of tools into the blocks. In particular, the application and usage module 220 creates a visual representation of the blocks within the project planning that takes a weight of required factors and optional factors into account.

In embodiments, the application and usage module 220 determines which blocks are required and which blocks are optional. The application and usage module 220 determines which factors are essential for the project and which factors can be adjusted or changed. The application and usage module 220 fits the blocks into a fixed-sized container (e.g., a box) and calculates the amount of effort needed from required factors and optional factors based on the blocks that fit into the container. The application and usage module 220 estimates a time of the team member, asset utilization, and other factors most efficiently from a multi-dimensional view.

In embodiments, the application and usage module 220 utilizes and communicates with the project planning server 208 to visualize the project planning and assess the progress of the project. The application and usage module 220 identifies any potential issues or risks that may arise and monitors the progress of the project to ensure that the project is proceeding as expected.

In embodiments, the application and usage module 220 monitors and adjusts the project planning as needed. In particular, the application and usage module 220 regularly checks the project planning server 208 for any errors or issues and adjusts or updates the project planning server 208 to ensure optimal system performance. The application and usage module 220 utilizes the project planning server 208 to optimize the project planning and maximize efficiency. The application and usage module 220 employs and communicates with the project planning server 208 to identify areas where improvements can be made and efficiency can be maximized.

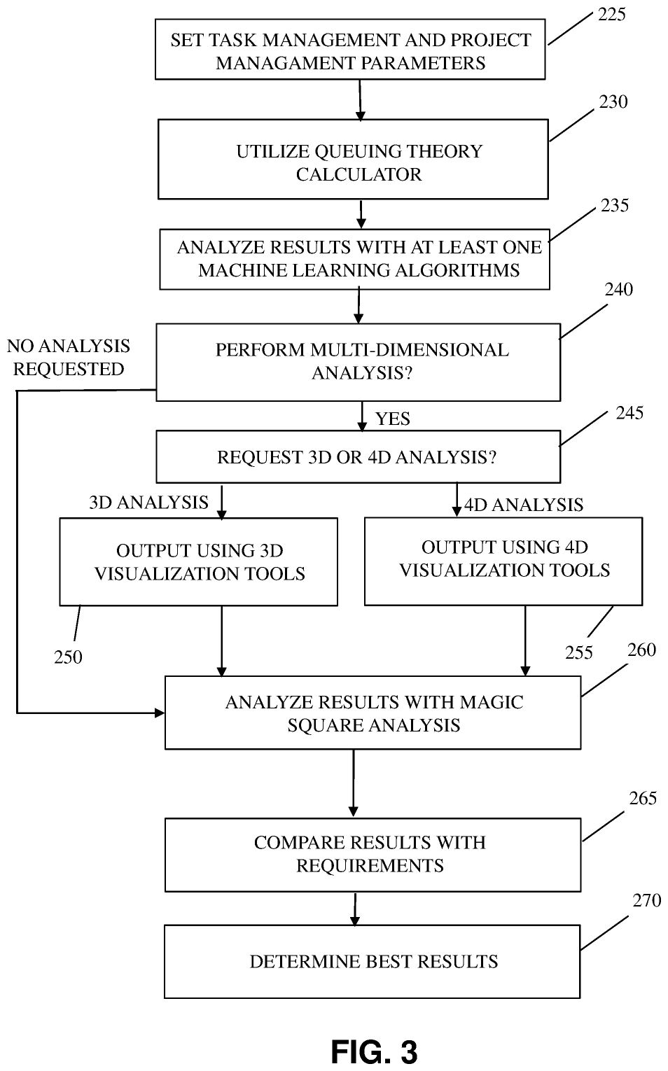

FIG. 3 shows a flowchart of an exemplary method of the project planning server in accordance with aspects of the present invention. Steps of the method may be carried out in the environment of FIG. 2 and are described with reference to elements depicted in FIG. 2.

At step 225, the system sets, at the system configuration and setup module 210, task management and project management parameters. At step 230, the system utilizes, at the implementation processing and system buildout module 212, a queuing theory calculator for task and project management based on various types of multi-dimensional visualization to generate results. At step 235, the system analyzes, at the implementation processing and system buildout module 212, the results with at least one machine learning (ML) algorithm.

At step 240, the system requests, at the implementation processing and system buildout module 212, the system requests a user to indicate whether to perform multi-dimensional analysis. At step 245, the system requests, at the implementation processing and system buildout module 212, the system requests the user to indicate whether the user wants to perform 3D or 4D analysis in response to the user requesting to perform multi-dimensional analysis. The system will move to step 260 in response to the user not requesting to perform multi-dimensional analysis.

At step 250, the system outputs, at the implementation processing and system buildout module 212, 3D analysis using 3D visualization tools in response to the user requesting to perform 3D analysis. At step 255, the system outputs, at the implementation processing and system buildout module 212, 4D analysis using 4D visualization tools in response to the user requesting to perform 4D analysis. At step 260, the system analyzes, at the implementation processing and system buildout module 212, the results with magic square analysis.

At step 265, the system compares, at the implementation processing and system buildout module 212, the results with requirements of the user. In embodiments, and with respect to FIG. 2, the implementation processing and system buildout module 212 compares the results with the requirements of the user based on the analysis of the results with the at least one machine learning algorithm and the analysis of the results using the magic square analysis. At step 270, the system determines, at the implementation processing and system buildout module 212, the best results based on a comparison of the results with requirements of the user. In embodiments, and with respect to FIG. 2, the implementation processing and system buildout module 212 determines the best results (i.e., a subset of the plurality of results) which meet a threshold of a comparison of the requirements of the user based on comparing the plurality of results with the requirements of the user. In embodiments and as discussed with regards to FIG. 2, the at least one ML algorithm analyzes the various results using trained models and historical data to build intelligent workflows that show the resource utilization of required factors and optional factors. Further, in embodiments, the magic square analyzes the various results by providing a multi-dimensional visualization of the various results to visualize each of the required factors and the optional factors. Accordingly, by using the analysis of the at least one machine learning algorithm and the magic square analysis, the implementation processing and system buildout module 212 compares the resource utilization of the required factors and optional factors to the requirements of the user and provides the best results (i.e., a subset of the plurality of results) to the user based on the comparison.

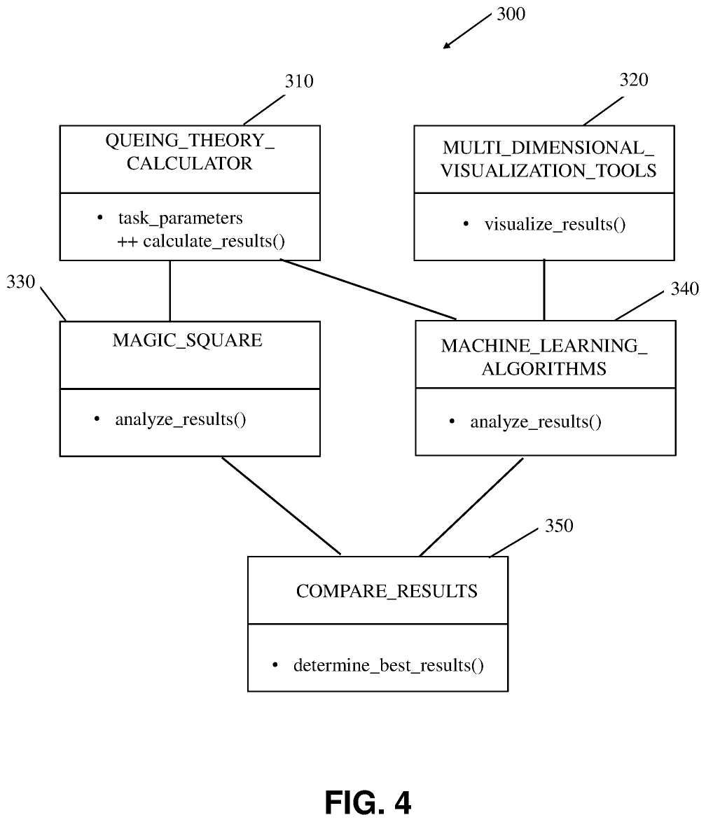

FIG. 4 shows a data entity contextual diagram of the project planning server in accordance with aspects of the present invention. In FIG. 4, the data entity contextual diagram 300 includes a queuing_theory_calculator 310, a multi_dimensional_visualization_tools 320, a magic_square 330, machine_learning_algorithms 340, and compare_results 350. In embodiments, the queuing_theory_calculator 310 includes task_parameters and a function of calculate_results( ) to use task parameters and calculate results and sends the results to the magic_square 330 and the machine_learning_algorithms 340. The multi_dimensional_visualization_tools 320 includes a function of visualize_results( ) to visualize the results and send the results to the machine_learning_algorithms 340.

In embodiments, the magic_square 330 includes a function of analyze_results( ) to analyze the results and sends an analysis of the results to the compare_results 350. The machine_learning_algorithms 340 include the function of analyze_results( ) to analyze the results and sends the analysis of the results to the compare_results 350. The compare_results 350 include the function of determine_best_results( ) to determine the best results based on the analysis of the results.

The project planning server 208 of FIG. 2 is configured to be used in different scenarios. In an example, a project manager is responsible for managing a large, multi-disciplinary project for a company. The project manager is overwhelmed with the complexity of the project and the number of stakeholders involved. The project manager wishes to create a project plan that takes into account all of the required factors and optional factors. The project manager visualizes the project planning process in a way that enables identification of potential points of failure and proactively addresses any risks associated with the project. The project manager uses the project planning server 208 to visualize the project planning process in a multi-dimensional view. The project manager views the project requirements in terms of complexity, skills set of personnel, availability of personnel and tools, and business processes. The project manager is then able to see how the required factors and optional factors interact with each other. The project manager generates an effective project plan that takes into account all of the factors and provides the project manager with needed information to make informed decisions.

In another example, a project manager is responsible for development of a new product. The project manager has been tasked with a project and is looking for a way to efficiently plan and manage the project. The project manager uses the project planning server 208 to plan the project. The project manager visualizes the project planning process by taking into account the weight of required factors and optional factors. The project manager estimates the time of team members, asset utilization, and other factors most efficiently. The project manager is able to determine which factors are required and which are optional based on a nature of a project and an intended goal of accomplishment. The project manager determines how many optional blocks fit into the remaining spots in the box, and derives the amount of effort needed from the required factors and optional factors based on the blocks that fit in.

In another example, a worker in a finance industry is responsible for managing large and complex projects. The worker creates a project plan that takes into account all of the required factors and optional factors. The worker uses the project planning server 208 to visualize the project planning process with multi-dimensional visualization. The worker is able to view the project requirements in terms of complexity, personnel skill sets, availability of personnel and tools, and business processes. The worker can then see how the required factors and optional factors interact with each other. The worker identifies potential points of failure and proactively addresses any risks associated with the project. The worker is able to generate an effective project plan that takes into account all of the factors and provides with the information the worker needs to make informed decisions. Also, the worker uses the project planning server 208 to see when there are times when the worker will have a data rich or data poor modeling approach based on known factors that the worker can feed the model.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
setting, by a processor set, task management parameters and project management parameters;
utilizing, by the processor set, a queuing theory calculator for a task management and a project management based on various types of multi-dimensional visualization;
generating, by the processor set, a plurality of results of the task management and the project management based on utilizing the queuing theory calculator;
analyzing, by the processor set, the plurality of results with at least one machine learning algorithm;
outputting, by the processor set, a multi-dimensional analysis of the plurality of results based on the analysis of the plurality of results with the at least one machine learning algorithm;
analyzing, by the processor set, the plurality of results using a magic square analysis;
comparing, by the processor set, the plurality of results with a plurality of requirements based on the analysis of the plurality of results with the at least one machine learning algorithm and the analysis of the plurality of results using the magic square analysis; and
determining, by the processor set, a subset of the plurality of results that meet a threshold of a comparison of the requirements based on the comparing of the plurality of results with the requirements.

2. The computer-implemented method of claim 1, wherein the task management parameters and the project management parameters comprise a complexity of project requirements, a plurality of skill sets of people, availability of the people, a plurality of business processes, and availability of tools.

3. The computer-implemented method of claim 1, wherein the at least one machine algorithm comprises at least one selected from a group consisting of: linear regression, decision tree learning, and a support vector machine (SVM).

4. The computer-implemented method of claim 1, wherein the magic square analysis comprises a multi-dimensional grid of distinct numbers where all rows, columns, and diagonals sum to a same total.

5. The computer-implemented method of claim 1, wherein the outputting the multi-dimensional analysis of the results comprises outputting a three-dimensional (3D) analysis of the results using 3D visualization tools.

6. The computer-implemented method of claim 5, wherein the 3D analysis comprises a triple constraint that includes a resource planning, a funding planning, and a scope planning.

7. The computer-implemented method of claim 1, wherein the outputting the multi-dimensional analysis of the results comprises outputting a four-dimensional (4D) analysis of the results using 4D visualization tools.

8. The computer-implemented method of claim 7, wherein the 4D analysis comprises a triple constraint and a time planning.

9. The computer-implemented method of claim 8, wherein the triple constraint includes a resource planning, a funding planning, and a scope planning.

10. The computer-implemented method of claim 8, wherein the time planning comprises a predetermined time range for the results.

11. The computer-implemented method of claim 1, further comprising inputting the plurality of requirements that comprise at least one project requirement.

12. A computer program product comprising one or more computer readable storage media having program instructions collectively stored on the one or more computer readable storage media, the program instructions executable to:
set task management parameters and project management parameters;
utilize a queuing theory calculator for a task management and a project management based on various types of multi-dimensional visualization;
generate a plurality of results of the task management and the project management based on utilizing the queuing theory calculator;
analyze the plurality of results with at least one machine learning algorithm;
output a multi-dimensional analysis of the results based on the analysis of the plurality of results with the at least one machine learning algorithm;
analyze the plurality of results using a magic square analysis;
compare the plurality of results with a plurality of requirements based on the analysis of the plurality of results with the at least one machine learning algorithm and the analysis of the plurality of results using the magic square analysis; and
determine a subset of the plurality of results that meet a threshold of a comparison of the requirements based on the comparing of the plurality of results with the requirements.

13. The computer program product of claim 12, wherein the task management parameters and the project management parameters comprise a complexity of project requirements, a plurality of skill sets of people, availability of the people, a plurality of business processes, and availability of tools.

14. The computer program product of claim 12, wherein the at least one machine algorithm comprises at least one selected from a group consisting of: a linear regression, a decision tree learning, and a support vector machine (SVM).

15. The computer program product of claim 12, wherein the magic square analysis comprises a multi-dimensional grid of distinct numbers where all rows, columns, and diagonals sum to a same total.

16. The computer program product of claim 12, wherein the outputting the multi-dimensional analysis of the results comprises outputting a three-dimensional (3D) analysis of the results using 3D visualization tools.

17. The computer program product of claim 12, wherein the outputting the multi-dimensional analysis of the results comprises outputting a four-dimensional (4D) analysis of the results using 4D visualization tools.

18. A system comprising:
a processor set, one or more computer readable storage media, and program instructions collectively stored on the one or more computer readable storage media, the program instructions executable to:
set task management parameters and project management parameters;
utilize a queuing theory calculator for a task management and a project management based on various types of multi-dimensional visualization;
generate a plurality of results of the task management and the project management based on utilizing the queuing theory;
analyze the plurality of results with at least one machine learning algorithm;
output a multi-dimensional analysis of the plurality of results based on the analysis of the plurality of results with the at least one machine learning algorithm;
analyze the plurality of results using a magic square analysis;
compare the plurality of results with a plurality of requirements based on analysis of the plurality of results with the at least one machine learning algorithm and the analysis of the plurality of results using the magic square analysis; and
determine a subset of the plurality of results that meet a threshold of a comparison of the requirements based on the comparing of the plurality of results with the requirements,
wherein the task management parameters and the project management parameters comprise a complexity of project requirements, a plurality of skill sets of people, availability of the people, a plurality of business processes, and availability of tools.

19. The system of claim 18, wherein the at least one machine algorithm comprises at least one selected from a group consisting of: a linear regression, a decision tree learning, and a support vector machine (SVM).

20. The system of claim 18, wherein the magic square analysis comprises a multi-dimensional grid of distinct numbers where all rows, columns, and diagonals sum to a same total.
